(19) United States
(12) Patent Application Publication
(10) Pub. No.: US 2014/0267724 A1
(43) Pub. Date: Sep. 18, 2014

(54) RECORDING SYSTEM AND METHOD FOR VEHICLE

(71) Applicant: PROGRESS RAIL SERVICES CORPORATION, Albertville, AL (US)

(72) Inventors: Todd Charles Goergen, Blue Springs, MO (US); Marc David Miller, Lee's Summit, MO (US); Gregory Joel Herman, Olathe, KS (US)

(73) Assignee: PROGRESS RAIL SERVICES CORPORATION, Albertville, AL (US)

(21) Appl. No.: 13/795,174

(22) Filed: Mar. 12, 2013

(51) Int. Cl. H04N 5/232

(52) U.S. Cl. CPC H04N 5/23222
USPC 348/148; 348/207.11

(57) ABSTRACT

A recording system may include a camera configured to record images including a first image and a storage device configured to store the images. The recording system may include a controller configured to identify at least one vertical line contained in the first image and determine whether the first image is indicative of a probable event area based on the identification of the at least one vertical line. The controller may be configured to command the camera to record the images at a first quality if the first image is indicative of a probable event area. The controller may also be configured to command the camera to record images at a second quality if the first image is not indicative of a probable event area. The images recorded at the second quality occupy less memory in the storage device than the images recorded at the first quality.

### TECHNICAL FIELD

This disclosure relates generally to event recorders and, more specifically, to a system and method for controlling data storage associated with an event recorder.

### BACKGROUND

Locomotives may include a system for receiving and logging operational data for use in troubleshooting or diagnosing a locomotive failure. These systems may include an event recorder that collects and communicates vehicle performance data received from multiple subsystems within the locomotive. In some systems, the data is collected periodically or in response to a triggering event or fault condition. This data may then be communicated to a remote location for analysis.

If an event occurs, such as a derailment, crash, or other mishap, the event recorder data may be useful to help determine the cause of the event, or conditions that may have contributed to the event. Some video recording data, while useful in recreating and analyzing an event, requires significant data storage. Therefore, it may be desirable to provide an event recorder that provides high resolution data without requiring significant data storage.

One system for storing operational data for a vehicle is disclosed U.S. Patent Application Publication No. 2011/0216200 A1 (“the '200 publication”). The '200 publication describes an imaging system for generating images taken from a rail vehicle. The system includes a camera configured to generate video data associated with a rail vehicle, and a processor configured to control recording of video data according to at least one of a variable frame rate or a variable resolution based on operating conditions of the rail vehicle.

The system provided by the '200 publication may suffer from a number of possible drawbacks. For example, the '200 publication requires, for wayside objects to be identified by the recording system, that the wayside object either be logged in a database or have an automated equipment identifier tag that is readable by the recording system. Furthermore, the system of the '200 publication is designed to manage memory storage by overwriting data or compressing data. These solutions decrease the reliability of such data for evidentiary purposes.

The presently disclosed systems and methods are directed to overcoming and/or mitigating one or more of the possible drawbacks set forth above and/or other problems in the art.

### SUMMARY

In accordance with one aspect, the present disclosure is directed to a recording system. The recording system may include a camera configured to record images including a first image and a storage device configured to store the images. The recording system may also include a controller configured to identify at least one vertical line contained in the first image and determine whether the first image is indicative of a probable event area based on the identification of the at least one vertical line. The controller may be configured to send a command to the camera to record the images at a first quality if the first image is indicative of a probable event area. The controller may also be configured to send a command to the camera to record the images at a second quality if the first image is not indicative of a probable event area, wherein the images recorded at the second quality occupy less memory in the storage device than the images recorded at the first quality.

In accordance with another aspect, the present disclosure is directed to a computer-implemented method including receiving images including a first image and identifying, via a processor, at least one vertical line contained in the first image. The method also includes determining whether the first image is indicative of a probable event area based on the identification of the at least one vertical line and, if the first image is indicative of a probable event area, recording the images at a first quality. If the first image is not indicative of a probable event area, the method includes recording the images at a second quality, wherein the images recorded at the second quality occupy less memory in a storage device than the images recorded at the first quality.

According to yet another aspect, the present disclosure is directed to a locomotive. The locomotive may include a camera configured to record images including a first image. The locomotive may also include a storage device configured to store the images. The locomotive may also include a controller. The controller may be configured to identify at least one vertical line contained in the first image and determine whether the first image is indicative of a probable event area based on the identification of the at least one vertical line. The controller may be configured to send a command to the camera to record the images at a first quality if the first image is indicative of a probable event area. The controller may also be configured to send a command to the camera to record the images at a second quality if the first image is not indicative of a probable event area, wherein the images recorded at the second quality occupy less memory in the storage device than the images recorded at the first quality.

### BRIEF DESCRIPTION OF THE DRAWINGS

FIG. 1 is a perspective view of an exemplary embodiment of a locomotive.

FIG. 2 is a schematic diagram of an exemplary embodiment of a recording system.

FIG. 3 is a flowchart of an exemplary embodiment of a method for controlling data storage associated with a recording system.

### DETAILED DESCRIPTION

FIG. 1 shows an exemplary locomotive 100 in which systems and methods for recording events may be implemented consistent with the disclosed exemplary embodiments. Locomotive 100 may include a power system 150 for powering locomotive 100. In one embodiment, power system 150 may include, for example, a uniflow two-stroke diesel engine system. Power system 150 may also include controls for designating the direction, speed, and braking of locomotive 100. Power system 150 may have a power characteristic that describes a current property of power system 150. The power characteristic may include, for example, temperature, power level, fuel efficiency, and fuel level. The power characteristics may also define characteristics of the vehicle (e.g., locomotive 100) as they relate to power. For example, power characteristics may also be indicative of vehicle speed and/or the operation mode associated with the vehicle. For example, the operation mode may include an OFF mode and an ON mode. The ON mode may be one or more of a power mode, a secondary power mode, a dynamic braking mode, a blended brake mode, an emergency brake mode, a rollback mode, and an opposite-direction brake mode.

In addition to power system 150, locomotive 100 may also include a recording system 200 for obtaining and storing signal data. According to some embodiments, at least a portion of recording system 200 may be located at or near the front of locomotive 100. For example, FIG. 2 shows an exemplary embodiment of a recording system 200 for storing data for locomotive 100. Recording system 200 may include one or more cameras 210 for capturing images. Returning to FIG. 1, camera 210 may be a front-facing camera positioned behind the nose windshield of locomotive 100. Camera 210 may be a video camera capable of capturing a continuous stream of images. Additionally or alternatively, camera 210 may be configured to record images periodically. Camera 210 may be able to operate at a first quality and a second quality, wherein images recorded at the second quality occupy less memory when stored. For example, camera 210 may have a high resolution mode (e.g., corresponding to a first quality) and a low resolution mode (e.g., corresponding to a second quality). Another difference between high quality and low quality may include the frame rate at which the images are recorded. Any measure of quality that can be adjusted while data is being recorded, rather than at any point post-capture, can characterize the quality at which images are recorded. According to some embodiments, camera 210 may include multiple cameras, such that switching between high and low qualities changes the camera capturing the images. To store the images, recording system 200 may also include a storage device 220, such as a nonvolatile memory storage device.

Recording system 200 may include one or more controllers 230 (e.g., including one or more microprocessors) to control the quality at which images are recorded by camera 210. According to the embodiment shown in FIG. 2, recording system 200 may include a controller 230 dedicated to controlling camera 210. According to some embodiments, controller 230 may be one portion of a locomotive power controller configured to operate locomotive 100.

Controller 230 may embody a single processor or multiple processors that include a means for receiving data signals and storing and/or communicating at least a portion of time-stamped data signals. Additionally or alternatively, controller 230 may include a portion or all of recording system 200. Numerous commercially available processors can be configured to perform the functions of controller 230. It should be appreciated that controller 230 could readily embody a general machine or customized processor capable of controlling the operation of recording system 200. Controller 230 may include all components required to run an application, such as, for example, a memory, a secondary storage device, and a processor, such as a central processing unit or other known means. Various other known circuits may be associated with controller 230, including power source circuitry (not shown) and other appropriate circuitry. Controller 230 may be capable of receiving data signals as well as logging commands.

FIG. 3 is a flowchart of an exemplary embodiment of a computer-implemented method for controlling data storage associated with recording system 200. In this manner, recording system 200 may be capable of storing data for longer periods before overwriting old data, without compromising evidentiary value of the data due to traditional compression/decompression methods.

At step 310, controller 230 receives an image. According to some embodiments, controller 230 receives the image directly from camera 210. According to other embodiments, controller 230 receives the image from nonvolatile storage memory 220.

At step 320, controller 230 identifies one or more vertical lines contained in the image. Lines may be determined to be vertical based on a reference line and/or reference surface. According to some embodiments, vertical lines are those that are vertical with respect to the ground. For example, the ground may include the surface of the ground on which the railway is located. For another example, the ground may include the surface of the ground where the object indicated by the vertical line is located. In this example, vertical lines may be identified by the right angle the object indicated by the vertical line makes with the ground. According to other embodiments, lines may be identified as vertical if they are at a ninety-degree angle to the horizon. According to some other embodiments, controller 230 may include a subsystem that is capable of determining the direction of gravity, such as a compass or a gyroscope. According to those embodiments, a line that is parallel with the direction of gravity may be identified as vertical.

Based on analysis of the image, including the identification of vertical lines, at step 330, controller 230 determines whether the image is indicative of a probable event area, which is an area in which events are deemed more likely to occur based on environmental factors. The event is likely enough to occur that it is considered worthwhile to increase the quality or frequency of the camera activity. It is in these probable event areas that high resolution data collection may be desirable. For example, a collision with a car is more likely to occur in populated areas than in remote areas. Thus, populated areas may be one example of a probable event area. Furthermore, signs posted near the railroad may be indicative of a change in condition that a locomotive controller should keep in mind. For example, signs may be indicative of falling rocks or of upcoming curves. Thus, areas near railway signs may be another example of a probable event area.

Multiple algorithms may be used to detect vertical lines in an image. Further, different image processing methods may be used to determine additional characteristics of an image. For example, in recording systems 200 that are associated with locomotive 100, camera 210 may be configured such that the parallel lines of the railway are visible within each image. Additional processing could determine a relative distance between detected vertical lines from the railway. With this information, controller 230 may determine that a particular vertical line is indicative of a building located remotely from the railway, which may have no effect on whether recording system 200 is in a probable event area. On the other hand, controller 230 may determine, based on the relative distance of the vertical line to the railway, that locomotive 100 is approaching a cross guard or a rail sign. According to some embodiments, the identification of a rail sign or a cross guard may be indicative of a probable event area.

According to some embodiments, controller 230 may be able to distinguish between vertical lines indicative of man-made structures, like buildings, from vertical lines indicative of natural structures, like forestry and other vegetation. For example, camera 210 may be capable of outputting image data with an infrared spectrum, that provide information useful in distinguishing man-made structures from vegetation. According to some embodiments, controller 230 may perform additional signal processing to identify smooth surfaces and other characteristics of man-made structures. According to some embodiments, the presence of natural structures, even if they produce vertical lines, may not be relevant to a determination of whether the area is a probable event area.

Not every man-made structure necessarily factors into whether an area is a probable event area. According to some embodiments, other characteristics of identified man-made structures, such as height and visible surface area, may be relevant to this analysis. For example, 90 degree angles are indicative of man-made structures. For another example, flat surfaces bordered on either side by vertical lines (and topped with a horizontal line), may be indicative of a tunnel. This may trigger a probable event area label. According to some embodiments, controller 230 may ignore any vertical lines indicative of natural structures for the purpose of determining whether the image is indicative of a probable event area. According to some embodiments, controller 230 identifies an area as probable event if man-made structures are identified within a predefined distance from the camera. This predefined distance may be preprogrammed, or may be variable, based on factors, such as the particular location of locomotive 100.

Additionally, controller 230 may detect patterns in the vertical lines to provide further information about the image. For example, repetitive vertical lines that are equidistant from each other, as well as from the railway, may be indicative of power poles or telephone poles. According to some embodiments, analysis of whether an area is probable event may exclude from consideration any vertical lines indicative of power or telephone poles.

Controller 230 may combine the information contained in the image with other information to determine whether an area is probable event. For example, controller 230 may associate a location (e.g., a GPS location) with a probable event area. According to some embodiments, this may include adjusting the image analysis based on a location. For example, if the location indicates that recording system 200 is in a densely populated area, the predefined distance from the railway that man-made structures reside in order to qualify as probable event may be increased to allow for more vertical lines to trigger the probable event area label. According to some embodiments, controller 230 may associate a probable event area with its location to be stored in a database for future use.

If controller 230 determines at step 330 that the image is indicative of a probable event area, then at step 340, controller 230 commands camera 210 to record image data at a first quality, wherein the first quality images occupy more space than images recorded at the lower, second quality. Alternatively, if controller 230 determines that the image is not indicative of a probable event area, at step 350 controller 230 may command camera 210 to record images at the second quality.

According to some embodiments, controller 230 may be configured to switch between image collection at a first quality and at a second quality based on other factors. For example, controller 230 may be configured to detect audio signals and determine whether those signals are indicative of a probable event area. For signals that are indicative of a probable event area, controller 230 may be configured to switch to collecting data at a first quality in response to these sounds. For example, these sounds may include a horn (such as a car horn or a locomotive horn), a crossing bell, and/or a locomotive bell. Other types of audio signals may be used by controller 230 to control the quality at which the images are being captured.

For example, controller 230 may be configured to switch between a first quality and a second quality based on the travel speed of recording system 200. For example, controller 230 may be configured to detect when the travel speed (e.g., of camera 210 or locomotive 100 on which camera 210 is installed) exceeds a threshold speed. Once the threshold is exceeded, controller 230 may send a command to camera 210 to record images at a first quality. According to some embodiments, the threshold may be programmed to capture images at a first quality when the speed exceeds a speed that is faster than a normal or expected operating speed. For example, when locomotive 100 exceeds a speed limit, controller 230 can be configured to begin recording images at a first quality. Additionally or alternatively, the threshold could be configured to capture images at a first quality once the speed reaches a normal operating speed. The incorporation of the speed-dependent control of the camera could be configured to override the line-detection method. Alternatively, the two controls can function together. For example, according to some systems, if the threshold speed is not met, than the quality at which images are captures relies on the vertical line detection, and when the threshold speed is exceeded, the images are measured at a first quality for a period of time, and then the system returns to relying on the line detection method.

According to some embodiments, the method described in FIG. 3 may be conducted in a continuous manner, such that at regular intervals, controller 230 once again reassesses whether the images should be recorded at the first quality or at the second quality. In this manner, controller 230 can continue to switch between a first quality and a second quality in a way that improves the quality when desired while still decreasing the memory cost when the higher quality is no longer desirable. Controller 230 may sample images already recorded to analyze the images for the purpose of determining whether the quality at which these images is being recorded should be adjusted, based on the content of the images themselves.

### INDUSTRIAL APPLICABILITY

The disclosed system and method may provide a robust mechanism for switching between high resolution and low resolution data storage. The presently disclosed systems and methods may have several possible advantages. For example, this system may dynamically change the quality of recorded data in response to identifying particular environmental factors.

Additionally, this system may provide the advantage of not changing the images post-capture, which can distort the data captured in the images. For example, compression and decompression, which can compromise the reliability of such data for evidence purposes, may not be needed to efficiently use nonvolatile storage memory on the device in an efficient way. Instead, even if an incident occurs in an area not identified as a probable event area, the low resolution data captured by the recording system still provides reliable evidence.

Additionally, there may be a reduced heat dissipation in a crash-worthy storage device, which is insulated against fire destroying the storage device (i.e. the recording medium) in the event of a crash. This allows for a larger amount of storage per device. Additionally, the disclosed system is capable of storing recordings for a longer period of time, even on a limited size recording medium. That is, more data may be able to be recorded without the need for compression, which devalues data for evidentiary purposes.

It will be apparent to those skilled in the art that various modifications and variations may be made to the disclosed systems and methods for data storage. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A recording system, comprising:
a camera configured to record images including a first image;
storage device configured to store the images; and
a controller configured to:
identify at least one vertical line contained in the first image;
determine whether the first image is indicative of a probable event area based on the identification of the at least one vertical line;
if the first image is indicative of a probable event area, send a command to the camera to record the images at a first quality; and
if the first image is not indicative of a probable event area, send a command to the camera to record the images at a second quality,
wherein the images recorded at the second quality occupy less memory in the storage device than the images recorded at the first quality.

2. The recording system of claim 1, wherein images recorded at the first quality have a higher resolution than images recorded at the second quality.

3. The recording system of claim 1, wherein the controller is further configured to distinguish between a first vertical line indicative of man-made structures from a second vertical line indicative of natural structures.

4. The recording system of claim 3, wherein the controller is further configured to determine that the first image is indicative of a probable event area based on the presence of man-made structures within a predefined distance from the camera.

5. The recording system of claim 3, wherein the controller is further configured to ignore any vertical lines indicative of telephone poles for the purpose of determining whether the first image is indicative of a probable event area.

6. The recording system of claim 5, wherein the controller is further configured to ignore any vertical lines indicative of natural structures for the purpose of determining whether the first image is indicative of a probable event area.

7. The recording system of claim 6, wherein the controller is further configured to associate the probable event area with a location.

8. The recording system of claim 1, wherein the controller is further configured to:
determine that a travel speed associated with the camera has exceeded a predetermined threshold; and
based on the travel speed, send a command to record the images at the second quality.

9. The recording system of 8, wherein the controller is further configured to:
determine whether an audio signal is indicative of a probable event area; and
if the audio signal is indicative of a probable event area, send a command to the camera to record the images at a first quality

10. A computer-implemented method, comprising:
receiving images including a first image;
identifying, via a processor, at least one vertical line contained in the first image;
determining whether the first image is indicative of a probable event area based on the identification of the at least one vertical line;
if the first image is indicative of a probable event area, recording the images at a first quality; and
if the first image is not indicative of a probable event area, recording the images at a second quality,
wherein the images recorded at the second quality occupy less memory in a storage device than the images recorded at the first quality.

11. The computer-implemented method of claim 10, wherein the images recorded at the first quality have a higher resolution than images recorded at the second quality.

12. The computer-implemented method of claim 10, further including distinguishing vertical lines indicative of man-made structures from vertical lines indicative of natural structures.

13. The computer-implemented method of claim 12, further including determining that the first image is indicative of a probable event area based on the presence of man-made structures within a predefined distance from the camera.

14. The computer-implemented method of claim 13, wherein the controller is further configured to ignore any vertical lines indicative of natural structures for the purpose of determining whether the first image is indicative of a probable event area.

15. The computer-implemented method of claim 14, further including ignoring any vertical lines indicative of telephone poles for the purpose of determining whether the first image is indicative of a probable event area.

16. The computer-implemented method of claim 10, further including:
determining that a travel speed associated with the camera has exceeded a predetermined threshold; and
based on the travel speed, send a command to record the images at the second quality.

17. The computer-implemented method of claim 16, further including:
determining whether an audio signal is indicative of a probable event area; and
if the audio signal is indicative of a probable event area, sending a command to the camera to record the images at a first quality

18. A locomotive, comprising:
a camera configured to record images including a first image;
a storage device configured to store the images; and
a controller configured to:
analyze the first image to identify at least one vertical line contained in the first image;
determine whether the first image is indicative of a probable event area based on the identification of the at least one vertical line;
if the first image is indicative of a probable event area, send a command to the camera to record the images at a first quality; and
if the first image is not indicative of a probable event area, send a command to the camera to record the images at a second quality,
wherein the images recorded at the second quality occupy less memory in the storage device than the images recorded at the first quality.

19. The locomotive of claim 18, wherein the images recorded at the first quality have a higher resolution than the images recorded at the second quality.

20. The locomotive of claim 18, wherein the controller is further configured to distinguish a first vertical line indicative of man-made structures from a second vertical line indicative of natural structures.

21. The locomotive of claim 20, wherein the controller is further configured to determine that the first image is indicative of a probable event area based on the presence of man-made structures within a predefined distance from the camera.

22. The locomotive of claim 21, wherein the controller is further configured to ignore any vertical lines indicative of natural structures for the purpose of determining whether the first image is indicative of a probable event area.

23. The locomotive of claim 22, wherein the controller is further configured to ignore any vertical lines indicative of telephone poles for the purpose of determining whether the first image is indicative of a probable event area.

24. The locomotive of claim 23, wherein the controller is further configured to associate the probable event area with a location.

25. The locomotive of claim 18, wherein the controller is further configured to:
determine that a travel speed associated with the locomotive has exceeded a predetermined threshold; and
based on the travel speed, send a command to record the images at the second quality.

26. The locomotive of claim 25, wherein the controller is further configured to:
determine whether an audio signal is indicative of a probable event area; and
if the audio signal is indicative of a probable event area, send a command to the camera to record the images at a first quality
